(19) United States
(12) Patent Application Publication
(10) Pub. No.: US 2018/0367898 A1
(43) Pub. Date: Dec. 20, 2018

(54) USER DEVICE AND METHOD FOR DRIVING A SPEAKER IN THE USER DEVICE

(71) Applicants: Mahmod ALRAWI, Kista (SE); Kang AN, Kista (SE); Senjun CHEN, Kista (SE); Haibo SHAN, Kista (SE); Fang-Ching LEE, Kista (SE); HUAWEI TECHNOLOGIES CO., LTD., Shenzhen, Guangdong (CN)

(72) Inventors: Mahmod ALRAWI, Kista (SE); Kang AN, Shenzhen (CN); Senjun CHEN, Shanghai (CN); Haibo SHAN, Shenzhen (CN); Fang-Ching LEE, Shanghai (CN)

(73) Assignee: Huawei Technologies Co., Ltd., Shenzhen, Guangdong (CN)

(21) Appl. No.: 16/060,241

(22) PCT Filed: Dec. 8, 2015
(86) PCT No.: PCT/EP2015/078929

§ 371 Date: Jun. 7, 2018

(51) Int. Cl. H04R 3/12; H04R 1/24

(52) U.S. Cl. CPC H04R 3/12; H04R 1/24; H04R 29/001; H04R 2420/01; H04R 2499/11; H04R 2430/03

(57) ABSTRACT

The present invention relates to a user device: a processor (20) configured to process an audio signal to derive a first driving signal and a second driving signal, such that the first driving signal comprises only components of the audio signal having frequencies higher than a threshold frequency and such that the second driving signal comprises components of the audio signal having frequencies above and below the threshold frequency; wherein the processor is configured to simultaneously provide the first driving signal and the second driving signal; a first speaker (30), being configured to generate sound based on the first driving signal; and a second speaker (40), being configured to generate sound based on the second driving signal. Furthermore, the present invention also relates to a corresponding method, a computer program, and a computer program product.

### TECHNICAL FIELD

The present invention relates to a user device. Furthermore, the present invention also relates to a method for driving a speaker in the user device, and a computer program product for implementing the method.

### BACKGROUND

A mobile phone has been largely used by people for communication, entertainment, and such. Typically a mobile phone has two different components for generating sound namely: ear speaker and main speaker. Usually, the ear speaker is used only when the mobile phone works in so called receiver mode or handheld mode, and the main speaker is used only when the mobile phone works in a hands-free mode or so called tweeter mode.

When the mobile phone is used for entertainment such as playing music, watching movie, and playing games, the mobile phone typically works in the hands-free mode or tweeter mode. In this situation, the mobile phone is expected to generate sound with large loudness and a good acoustic quality.

More and more mobile phones are designed as compact as possible, so there is only a very small space left for configuring a main speaker, which limits the size of a speaker selected as the main speaker. Accordingly, the loudness and acoustic quality of sound generated by the main speaker still cannot meet expected requirements.

### SUMMARY

An objective of embodiments of present invention is to provide a solution which can generate sound with a good acoustic quality and large loudness.

The above objective is achieved by the subject matter of the independent claims. Further advantageous implementation forms of the present invention can be found in the dependent claims corresponding to the possible implementation forms.

According to a first aspect of the invention, the above mentioned objective is achieved with a user device comprising:

a processor configured to process an audio signal to derive a first driving signal and a second driving signal, such that the first driving signal comprises only components of the audio signal having frequencies higher than a threshold frequency and such that the second driving signal comprises components of the audio signal having frequencies above and below the threshold frequency (i.e. also including the threshold frequency);

wherein the processor is configured to simultaneously provide the first driving signal and the second driving signal;

a first speaker, being configured to generate sound based on the first driving signal; and

a second speaker, being configured to generate sound based on the second driving signal.

In a first possible implementation form of the user device according to the first aspect, the processor is configured to adjust the threshold frequency.

In a second possible implementation form of the user device according to the first possible implementation form of the first aspect or according to the first aspect, the threshold frequency is 1000 Hz or a minimum of the adjustable threshold frequency is 1000 Hz.

In a third possible implementation form of the user device according to any one of preceding implementation forms of the first aspect or according to the first aspect, the audio signal comprises a first channel signal and a second channel signal; the processor is configured to filter the first channel signal to derive high frequency components of the first channel signal having frequencies higher than the threshold frequency and low frequency components of the first channel signal having frequencies not higher than the threshold frequency; the processor is configured to derive the first driving signal based on the high frequency components of the first channel signal (only); the processor is further configured to derive the second driving signal based on the second channel signal and the low frequency components of the first channel signal.

In a fourth possible implementation form of the user device according to the third possible implementation form of the first aspect, the processor is configured to calculate a volume difference between the first channel signal and the second channel signal, and the processor is configured to adjust the first driving signal and/or the second driving signal based on the calculated volume difference to reduce the volume difference between the first driving signal and the second driving signal when compared to the calculated volume difference.

In a fifth possible implementation form of the user device according to the third possible implementation form or the fourth possible implementation of the first aspect, the processor is configured to calculate the phase difference between the first channel signal and the second channel signal, and the processor is configured adjust the phase of the first driving signal and/or the phase of the second driving signal based on the calculated phase difference to set the phase difference between the first driving signal and the second driving signal to a preset phase difference.

In a sixth possible implementation form of the user device according to any of preceding possible implementation forms of the first aspect or according to the first aspect, the processor is configured to simultaneously provided the first driving signal and the second driving signal when the user device works in hands-free or tweeter mode, and the processor is configured to stop providing the second driving signal and continue providing the first driving signal (only) when switching the user to a receiver or handheld mode.

In a seventh possible implementation form of the user device according to any of preceding possible implementation forms of the first aspect or according to the first aspect, the processor is configured to obtain status information of the first speaker, and the processor is configured to adjust (or control) the threshold frequency based on the obtained status information of the first speaker.

In an eighth possible implementation form of the user device according to any of preceding possible implementation forms of the first aspect or according to the first aspect, the status information of the first speaker comprises at least one of the following: a current excursion, current temperature, a current lowest resonance frequency f0, and a current Q parameter of the first speaker.

In a ninth possible implementation form of the user device according to any of preceding possible implementation forms of the first aspect or according to the first aspect, the processor is configured to further obtain a temperature and/or of excursion of the first speaker, and to control the first driving signal (e.g. the amplitude of the first driving signal) to ensure that the first speaker won't be damaged due to too high temperature and/or too high excursion.

In a tenth possible implementation form of the user device according to any of preceding possible implementation forms of the first aspect or according to the first aspect, the processor is configured to adjust the first driving signal and the second driving signal to balance the volume of the sound generated by the first speaker and the volume of the sound generated by the second speaker.

In an eleventh possible implementation form of the user device according to any of preceding possible implementation forms of the first aspect or according to the first aspect, a size of the first speaker is smaller than a size of the second speaker.

In a twelfth possible implementation form of the user device according to any of preceding possible implementation forms of the first aspect or according to the first aspect, the first speaker is an ear speaker (also called receiver, typically used in a receiver or handheld mode) and the second speaker is a main speaker (also called tweeter, typically used in a tweeter or hands free mode).

According to a second aspect of the invention, the above mentioned objective is achieved with a method for driving speakers comprised in a user device.

The method comprises:

processing an audio signal to derive a first driving signal and a second driving signal, such that the first driving signal comprises only components of the audio signal having frequencies higher than a threshold frequency, and such that the second driving signal comprises components of the audio signal having frequencies above and below the threshold frequency; and

simultaneously providing the first driving signal to an first speaker and the second driving signal to a second speaker, wherein the first speaker and second speaker are comprised in the user device;

wherein the first driving signal is adapted to drive the first speaker to generate sound, and

the second driving signal is adapted to drive the second speaker to generate sound.

The present invention also relates to a computer program, characterized in code means, which when run by processing means causes said processing means to execute any method according to the present invention.

A number of advantages are provided by the present user device, method, and computer program according to the first aspect. In embodiments of the present invention, the first speaker is actually used as a complimentary to the second speaker by using it also as a tweeter. Based on this technique, the sound generated by the user device has a very large loudness. Further, the first speaker generates sounds of high frequencies, so the sound generated by the user device will contain more high frequency components, and then has a very good acoustic quality, as the high frequencies make the acoustic quality better. Moreover, by controlling that the first driving signal provided to the first speaker comprises only components of the audio signal having frequencies higher than the threshold frequency, no sounds of low frequencies needs to be generated by the first speaker, and then there is less or no noise like clipping would be generated, thereby further improving the acoustic quality of the sound generated by the user device. Furthermore, as typically the size of the first speaker is limited and smaller than the size of the second speaker by filtering out the lower frequencies the first speaker can be protected from overstress and damage. Furthermore, the second driving signal provided to the second speaker still comprises the frequencies below the threshold frequency, so the second speaker can generate sound of the low frequencies. Accordingly, the driving signals provided by this method can make the sound generated by the user device still comprise information related to the low frequencies, but without a noise like clipping.

### BRIEF DESCRIPTION OF THE DRAWINGS

The appended drawings are intended to clarify and explain different embodiments of the present invention, in which:

FIG. 1 shows a user device according to an embodiment of the present invention;

FIG. 2 shows an example of a frequency response of a speaker as used in a user device according to an embodiment of the present invention;

FIG. 3 shows an apparatus for driving speakers comprised in an user device according to an embodiment of the present invention;

FIG. 4 shows a method for driving speakers comprised in an user device according to an embodiment of the present invention.

### DETAILED DESCRIPTION

As described in the background part of this disclosure, a mobile phone, which has an ear speaker and a main speaker for working at different modes separately, does suffer problems in generating sound with a large loudness and good acoustic quality. Actually, any user equipment (UE) or user device using differently sized speakers which work at different modes face this problem. Embodiments of present invention are provided to solve the problem.

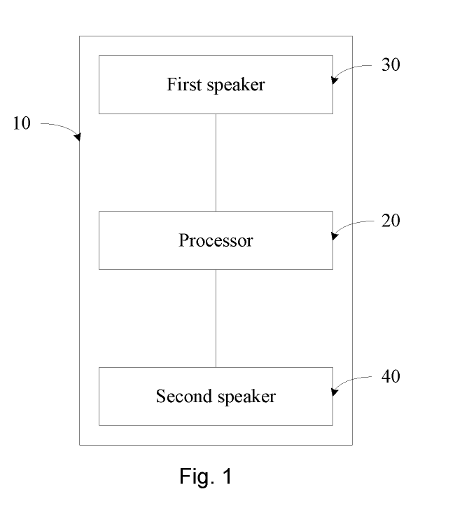

FIG. 1 shows a user device 10 (also designated as UE 10 in the following) according to an embodiment of present invention. The UE 10 comprises a processor 20, a first speaker 30, and a second speaker 40. It should be realised that the mentioned parts of UE 10 are suitably connected to each other by means of communication means which are illustrated with the lines in FIG. 1. The processor 20 is configured to provide a first driving signal to the first speaker 30 and a second driving signal to the second speaker 40. The first speaker 30 and the second speaker 40 are configured to generate sound respectively under the driving of their corresponding driving signals. The first speaker 30 is an ear speaker or receiver. The second speaker 40 is a main speaker or tweeter. A size of the first speaker 30 is smaller than a size of the second speaker 40.

The UE 10 can work either in a receiver mode/handheld mode or in a tweeter mode/hands-free mode. When the UE 10 works in the receiver mode/handheld mode, only the first speaker 30 generates sound (based on the first driving signal). When the UE 10 works in the tweeter mode/hands-free mode, the first speaker 30 can work as a tweeter together with the second speaker 40 to generate sound at the same time (based on the first driving signal and second driving signal as provided by the processor 20).

In the receiver mode/handheld mode, the processor 20 is configured to process an audio signal to derive a first driving signal, and to provide the first driving signal just to the first speaker 30.

In an embodiment, in the receiver/handheld mode the audio signal could be directly provided by the processor 20 as the first driving signal just to the first speaker 30, and the processing that the processor 20 implements on the audio signal is just to distribute the audio signal to the first speaker 30.

In another embodiment, the processing that the processor 20 implements on the audio signal to derive the first driving signal may comprise: removing some unwanted frequency components or noise from the audio signal, and providing the rest of the audio signal just to the first speaker 30 as the first driving signal. The processor 20 may remove the unwanted frequency or noise by filtering the audio signal. By removing the unwanted frequency or noise from the audio signal, the sound generated by the first speaker 30 would be pleasant to the ear.

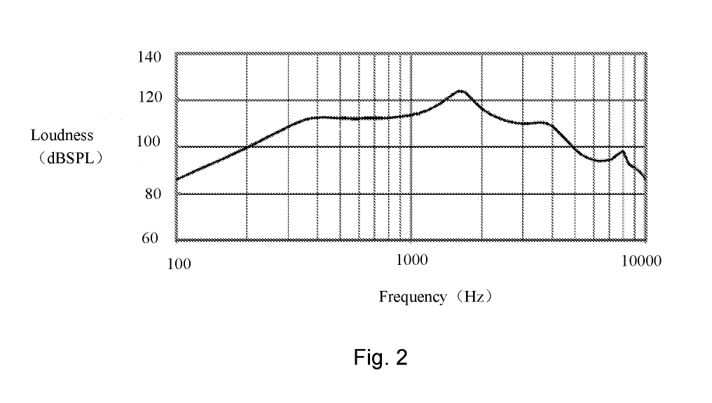

FIG. 2 shows an example of a frequency response of a speaker. The horizontal axis of FIG. 2 shows the frequency in Hz, while the vertical axis of FIG. 2 shows the loudness in dBSPL. It can be seen from the FIG. 2 that the frequency response in a frequency band between 300 Hz to 8000 HZ is relatively flat as compared with that in other bands. A flat frequency response could make the sound heard comfortable. To make the first speaker 30 to generate comfortable sound, the processor 20 is configured to implement a function of band-pass filter to remove the frequency components outside of the frequency band of 300 Hz to 8000 Hz, and to provide the filtered audio signal to the first speaker 30 as the first driving signal.

Though only two implementations of the processing implemented on the audio signal are described in above embodiments, the processing that the processor 20 implements on the audio signal may have many implementations, only if the result of processing the audio signal is to provide a first driving signal just to the first speaker 30.

When the UE 10 works in the tweeter mode/hands-free mode, the processor 20 is configured to process an audio signal to derive a first driving signal and a second driving signal, and to simultaneously provide the first driving signal and the second driving signal to the first speaker 30 and the second speaker 40 respectively. The first driving signal drives the first speaker 30 to generate sound, while the second driving signal drives the second speaker 40 to generate sound. It should be noted that the first signal for driving the first speaker 30 in tweeter mode or hands-free mode is obtained through the methods described in following embodiments.

In this embodiment, the first speaker is actually used as a complimentary to the second speaker by using it as a tweeter. Hence it can be achieved that the sound generated by the user device by driving both speakers 30, 40 simultaneously has a very large loudness.

Generally, generating sound with big volume is not a necessary ability for a speaker when the speaker is mainly used for the receiver mode/handheld mode. When people design an UE, the UE is typically expected to have a small size, light weight, and compact structure, so only a very narrow space is left for deploying the speaker used mainly for the receiver mode/handheld mode. Accordingly, the speaker deployed in the UE mainly for the receiver mode/handheld mode has to be small and thin. For a speaker used only for the tweeter mode/hands-free mode, generating sound with big volume is a necessary ability, so the speaker used mainly for the tweeter mode/hands-free mode always has a big size. However, the inventors found that: the speaker (the main speaker or tweeter) used only for the tweeter mode/hands-free mode generally has a better performance in generating sound at low frequencies than the speaker (the ear speaker or receiver) used only for the receiver mode/handheld mode, as the small size of the ear speaker or receiver limits excursion of the membrane of the speaker at low frequencies. This would lead to the ear speaker or receiver generating a noise like clipping for low frequency at high volume. Hence, if both the speaker used only for the receiver mode/handheld mode and the speaker used only for the tweeter mode/hands-free mode work at the same time, the acoustic quality of sound generated by them may be worse than that of the sound generated just by the speaker used mainly for the tweeter mode/hands-free mode, due to noise like clipping from the speaker used only for the receiver mode/handheld mode.

To avoid the problem mentioned above, the processor 20 is configured to process the audio signal, such that the derived first driving signal comprises only components of the audio signal having frequencies higher than a threshold frequency, and such that the second driving signal comprises components of the audio signal having frequencies above and below the threshold frequency. Just for clarification, it should be understood that the frequencies above and below shall also include the threshold frequency itself.

As the first driving signal provided by the processor 20 to drive the first speaker 30 comprises only components of the audio signal having frequencies higher than the threshold frequency, no sound at low frequencies needs to be generated by the first speaker 30, and accordingly no noise like clipping would be generated. Moreover, the second driving signal still comprises the frequencies below the threshold frequency, so the second speaker 40 can generate the sound at the low frequencies. Accordingly, the sound generated by the UE working in the tweeter mode/hands-free mode still comprises information related to the low frequencies, but without a noise like clipping.

Moreover, the more high frequencies components sound contains, the better acoustic quality the sound has. Accordingly, the acoustic quality of the sound generated by the UE 10 working in the tweeter mode/hands-free mode and simultaneously using the first speaker 30 and the second speaker 40 is better than that of sound generated by a UE only driving the speaker 40 when in tweeter mode/hands-free mode.

In the present disclosure, the user device and the user equipment are referred to the same article, and may be referred to such as a mobile telephone, a cellular telephone, a computer tablet or laptop with at least two speakers for generating sound. One of the at least two speakers (the first speaker 30) has a smaller size and is typically designed for being placed directly next to an ear, and another one of the at least two speakers (the second speaker 40) has a bigger size and is typically designed to being placed distant from the ear.

The processor 20 may process the audio signal in any one of following manners to derive the first driving signal and the second driving signal:

(1). The processor 20 copies components of the audio signal having frequencies higher than the threshold frequency, distributes them to a circuit connected to the first speaker 30 as the first driving signal, and distributes the audio signal to a circuit connected to the second speaker 40 as the second driving signal.

(2) The processor 20 splits the audio signal into two copies of the audio signal, filters one copy by using a high-pass filter to get the first driving signal, and distributes the other copy to the circuit connected to the second speaker 40 as the second driving signal. The cut-off frequency of the high-pass filter is the threshold frequency.

(3) The processor 20 splits the audio signal into two copies (first copy and second copy) of the audio signal, splits the first copy into a first part being components of the audio signal having frequencies higher than the threshold frequency and a second part being components of the audio signal having frequencies not higher than the threshold frequency, distributes the first part to the circuit connected to the first speaker 30 as the first driving signal, and mixes the second part with the second copy to form the second driving signal. In this embodiment, components of the first copy having frequencies not higher than the threshold frequency are not discarded, and are mixed with the second copy to drive the second speaker 40, thereby improving the loudness of sound at low frequencies generated by the UE.

In above embodiments, the audio signal is a single signal. In other embodiments, the audio signal may be composed of two signals or even more. For example, the audio signal is a stereo signal, which generally comprises at least a left channel signal and a right channel signal. The processor 20 separates the audio signal into the left channel signal and the right channel signal, and splits the right channel signal into two parts: the first part comprises the components of the right channel signal having frequencies higher than the threshold frequency, and the second part comprises the components of the right channel signal having frequencies not higher than the threshold frequency. The processor 20 provides the first part as the first driving signals to the first speaker 30. The processor 20 mixes the second part with the left channel signal to form the second driving signal, and provides the second driving signal to the second speaker 40.

Through providing the high frequency part, i.e. components with frequencies being higher than the threshold frequency, of the right channel signal to the first speaker 30 and providing the left channel signal and the low frequency part of the right channel to the second speaker 40, the UE 10 not only can generates stereo sound, but also is free of being bothered from a noise like clipping, thereby improving acoustic quality of the sound generated by the UE 10.

In above embodiment, it is the right channel signal of the audio signal that is split into two parts, and the only high frequency part of the right channel signal is provided to the first speaker 30.

In another embodiment, the processor splits the left channel signal into two parts, provides the part of the left channel signal with frequencies higher than the threshold frequency to the first speaker 30 as the first driving signal, and mixes the part of the left channel signal with low frequencies not higher than the threshold frequency with the right channel signal to form the second driving signal for the second speaker 40.

Though above embodiments take the audio signal being a stereo signal as an example, the audio signal may also be a mono signal, and the audio signal may be composed of two identical mono signals. The solution described above could also be applied to this situation, just by replacing the left channel with one mono signal and replacing the right channel with the other mono signal.

According to an embodiment of the present invention, the audio signal may be received by the processor 20 from a decoder comprised in the UE 10. In another embodiment, the audio signal is obtained by the processor 20 through decoding a sound file format with mp3, way, flac etc.

Generally, if it is expected to generate sound at low frequency with the same loudness as sound at high frequency, a speaker will consume much more energy or power, and the movement of the membrane of the speaker might be over the max excursion of this speaker, which may cause damage to the speaker. A speaker used as the first speaker 30 normally can work at high power mode only for a short term, but can continuously work at a low power mode. Typically, the speaker used as the first speaker 30 has a DC impedance of 32 Ohms, and can continuously work under a power up to 70 mW, but could only work for a short term if the power is up to 100 mW. When the first speaker 30 works as a tweeter in the tweeter mode/hands-free mode, the first speaker 30 is expected to generate sound in full frequency band of the audio signal with loudness as large as possible, so the first speaker 30 needs to be fed with high power. If the power fed to the first speaker 30 is too high, the first speaker 30 may be damaged. If the first speaker 30 only needs to generate sound in the high frequency band of the audio signal, the first speaker can still generate sound with large loudness by being fed with a relative low power, but has a low risk of being damaged. Accordingly, the processor 20 according to an embodiment will provide components of the audio signal in a low frequency band as less as possible to the first speaker 30, and sets the threshold frequency to a relative high frequency. For example, the threshold frequency may be set as 1000 Hz. By setting the threshold frequency as 1000 Hz, not only the speaker 30 will not generate a noise like clipping, but also it could be avoided that the first speaker 30 is damaged when it continuously works in the tweeter mode/handheld mode.

In other embodiments, the threshold frequency may be adjusted by the processor 20. The threshold frequency could be adjusted in a frequency range. In an embodiment, the minimum frequency of the frequency range is 1000 HZ.

In a further embodiment of the present invention, the processor 20 may further extract a sound character of the left channel signal and a sound character of the right channel before the right channel signal is split by the processor 20 into the two parts. The sound character of each channel may comprise at least one of the following: sound volume, phase, and energy distribution. The extraction of sound character is well known in the field and doesn't need to be explained.

Based on the sound volume of the left channel signal and the sound volume of the right channel signal, the processor 20 calculates sound volume difference between the left channel signal and the right channel signal. According to the sound volume difference, the processor 20 is further configured to adjust a sound volume of the first driving signal and/or a sound volume of the second driving signal to reduce a sound volume difference between the first driving signal and the second driving signal when compared to the sound volume difference between the right channel signal and the left channel signal.

As discussed before, the first speaker 30 has a smaller size as compared to the second speaker 40, so they have difference in the ability of generating sound even if they are fed with the same driving signal. For example, when the first speaker 30 and the second speaker 40 are fed with the same driving signal, the sound volume of sound generated by the first speaker 30 is much lower than the sound volume of sound generated by the second speaker 40, and the total sound field formed by the sound generated by the first speaker 30 and by the sound generated by second speaker 40 would be pulled to second speaker 40. By reducing the sound volume difference between the first driving signal and the second driving signal, the volume of sound generated by the first speaker 30 will be close to (even equal to) the volume of sound generated by the second speaker 40, and as an effect the stereo impression of the sound generated by the UE working in the tweeter mode/hands-free mode is enhanced.

Based on the phase of the right channel signal and the phase of the left channel, the processor 20 calculates a phase difference between the left channel signal and the right channel signal. According to the phase difference, the processor 20 adjusts a phase of the first driving signal and/or a phase of the second driving signal to set a phase difference between the first driving signal and the second driving signal to a preset phase difference. In this example, the preset phase difference can make people feel the sound generated by the UE 10 working in the tweeter mode/hands-free mode from a right or desired direction. Through controlling the phase difference between the first driving signal and the second driving signal, the sound generated by the UE 10 can make people have a feeling that the sound is from a specific direction, and thus the sound has a good stereo effect.

In a further embodiment of the present invention, both the sound volume difference between the first driving signal and the second driving signal and the phase difference between the first driving signal and the second driving signal are adjusted to achieve a good stereo effect.

In an embodiment of the present invention, the processor 20 may adjust the threshold frequency based on the energy distribution of the right channel. If the power distributed on low frequencies is lower than a safe level that keeps the first speaker 30 free of being damaged, the processor 20 adjusts the threshold frequency to a lower frequency. Through this adjustment, the first driving signal would comprise more low frequencies, and then the sound generated by the UE 10 would have an even better stereo effect.

In a more specific embodiment of the above mentioned embodiments, the processor 20 may further obtain status information of the first speaker 30. In an example, the status information of the first speaker 30 comprises at least one of the following: a lowest resonance frequency f0, and a Q parameter of the first speaker 30. The status information may be obtained by monitoring the voltage and/or current of the first driving signal fed to the first speaker 30. This monitoring may be implemented by a monitoring element comprised in the UE 10, and may also be implemented by the processor 20 itself. As an example a conventional smart power amplifier (PA) can be used for monitoring a speaker to get the above mentioned status information. Embodiments of the present invention may utilize such an existing element or device for monitoring the first speaker 30 to get the above mentioned status information. This status information is provided to the processor 20. If the processor 20 monitors the first speaker itself, the processor 20 may be configured to implement such a monitoring function itself.

Based on the obtained status information of the first speaker 30, the processor 20 may adjust the threshold frequency, to control which frequency components of the audio signal are to be provided to drive the first speaker 30 as the first driving signal. Through this way, the stereo effect of the sound generated by the first speaker 30 and the second speaker 40 is improved or enhanced.

The f0 and Q parameter of a speaker have an influence on the performance of the first speaker 30 at low frequencies. Some f0 and/or Q parameters could make the speaker still have a good performance at a relative low frequency, while other f0 and/or Q parameters could make the speaker have a good performance only at a relative high frequency. Accordingly, the threshold frequency may be set by referring to the f0 and/or Q parameter of the first speaker 30.

In an embodiment of the present invention, the threshold frequency may be set to the f0 of the speaker 30. In another embodiment, the threshold frequency may set as a value lower than the f0 of the speaker 30.

In another embodiment of the present invention, the threshold frequency may be set as:

$${F}_{threshold} = f 0 * [ 1 - K * \sqrt{Q * \frac{{P}_{Low}}{{P}_{Total}}} ] ,$$

where K is a weight coefficient, P_{Low} is the power of components of the audio signal with the frequencies below the f0, and P_{Total} is the total power of the audio signal. The weight coefficient may be a value between 0 and 1. The f0 and Q parameter of the first speaker 30 may be different when the UE 10 is used in different environments. When an environment, where the UE 10 is used, is changed, the f0 and Q parameter of the first speaker 30 may change. In an embodiment of present invention, the processor 20 obtains the current f0 and/or current Q parameter of the first speaker 30, and then adjusts the threshold frequency. In this embodiment, when the using environment of the UE 10 is changed, UE 10 can still generate sound with a good acoustic quality and/or a good stereo effect in the tweeter mode/hands-free mode by adjusting the threshold frequency.

In a further embodiment, the processor 20 may obtain current status information, e.g. current temperature or excursion of the first speaker 30, and adjusts the first driving signal to ensure that the current temperature and/or excursion won't exceed their corresponding permitted maximum value. Generally, the permitted maximum temperature is a temperature that the first speaker 30 is damaged once the temperature exceeds. If the first speaker 30 needs to generate loud sound comprising a lot of high frequencies components for a long period, a high temperature will be generated, and then the high temperature will cause some damage to the first speaker 30. To avoid the first speaker 30 is damaged by the high temperature, the processor 20 controls the amplitude of the first driving signal, so that the generated temperature won't damage the first speaker 30. The amplitude of the first driving signal can be controlled through many existing manners, for example, through implementing the function of a filter or limiter. If the current temperature is already over the permitted maximum value of the temperature, the processor 20 adjusts the amplitude of the first driving signal to a small value until the temperature monitored in real-time is below the permitted maximum value of the temperature. Afterwards the processor 20 may come back to normal operation and adjust the amplitude of the first driving signal to a desired level based on the input audio signal.

In a further embodiment, if the current temperature is below the permitted maximum value of the temperature, the processor 20 may adjust the amplitude of the first driving signal to a higher value, to make the first speaker 30 generate sound as loud as possible or to reduce a difference in volume between the first speaker 30 and the second speaker 40.

The excursion of the first speaker 30 can also be controlled by controlling or adjusting the amplitude of the first driving signal. The method for controlling the temperature can also be applied to controlling the excursion of the first speaker 30. In other words, the processor 20 is configured to adjust the first driving signal such that an excursion of the first speaker 30 is always below a predefined maximum value for the first speaker 30. As an example, the processor 20 may employ a limiter limiting the amplitude of the first driving signal to a value which generated an excursion of the first speaker 30 close to but still below the predefined maximum excursion.

In a further specific embodiment of above mentioned embodiments, the processor 20 may further adjust the first driving signal and/or the second driving signal to balance the volume of sound generated by the first speaker 30 and the volume of sound generated by the second speaker 40, before the first driving signal and the second driving signal are provided to the first speaker 30 and the second speaker 40 respectively.

The UE 10 may be freely switched between the receiver mode/handheld mode and the tweeter mode/hands-free mode. When the UE 10 switches from the tweeter mode/hands-free mode to the receiver mode/handheld mode, the processor 20 stops providing the second driving signal to the second speaker 40, but continues providing the first driving signal to the first speaker 30.

Though it is described in above embodiments that the UE 10 sometimes needs the first speaker 30 to generate sound and sometimes needs both the first speaker 30 and the second speaker 40 to generate sound, present invention can also apply to an UE which always needs both two speakers to work at the same time. The solution disclosed in above embodiments related to the tweeter mode/hands-free mode can be applied to this situation.

In an embodiment, the UE 10 may further comprise a first amplifier and a second amplifier (which are not shown in FIG. 1). The first amplifier is configured to control the gain of a driving signal provided by the processor 20 to the first speaker 30, and the second amplifier is configured to control the gain of a driving signal provided by the processor 20 to the second speaker 40.

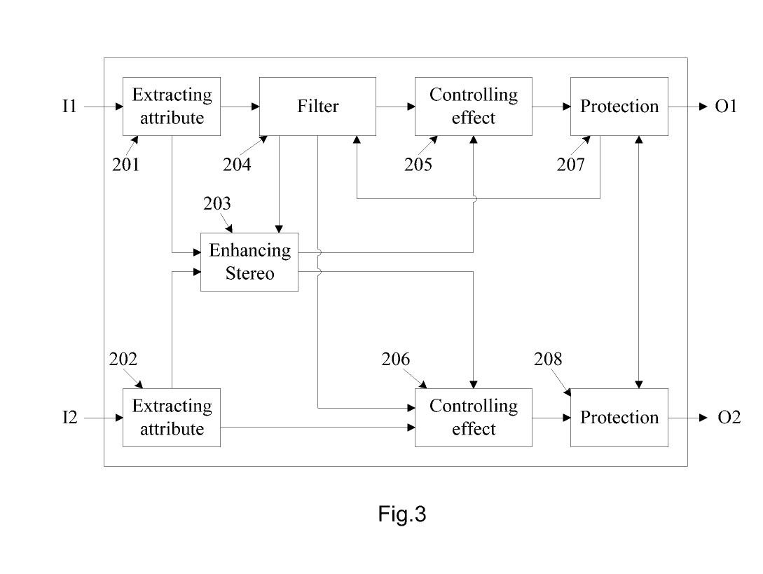

According to another embodiment, an apparatus as a possible implementation for the processor 20 mentioned in above embodiments is provided in FIG. 3. The apparatus comprises: extracting character elements 201, 202, an enhancing stereo element 203, a filter 204, controlling effect elements 205, 206, and protection elements 207, 208. Taking that an audio signal comprising a right channel signal 11 and a left channel signal 12 is processed to derive the first driving signal and the second driving signal as an example, the details of how each element works are described below.

The extracting character element 201 and the extracting character element 202 extract a sound character of a right channel signal 11 and a sound character of a left channel signal 12 respectively, and then respectively provide the sound character of the right channel signal 11 and the sound character of the left channel signal 12 to the enhancing stereo element 203. The sound character of each of the right channel signal 11 and the left channel signal 12 may respectively comprise at least one of the following: sound volume, phase, and energy distribution. The extracting character element 201 further provides the right channel signal 11 to filter 204, and the extracting character element 202 further provides the left channel signal 12 to controlling effect element 206.

The enhancing stereo element 203 calculates the difference between the sound character of the right channel signal 11 and the sound character of the left channel signal 12. The enhancing stereo element 203 may obtain the sound volume difference, or phase difference. Basing on the calculated sound volume difference and/or phase difference between the right channel signal 11 and the sound character of the left channel signal 12, the enhancing stereo element 203 may control the controlling effect element 205, and the controlling effect element 206.

The filter 204 splits the right channel signal 11 into two parts: a first part being the components of the right channel signal 11 having frequencies higher than the threshold frequency, a second part being the components of the sound signal 12 having frequencies not higher than the threshold frequency. The filter 204 is further configured to provide the first part to the controlling effect element 205 and to provide the second part to the controlling effect element 206.

The controlling effect element 205 provides the first part as the first driving signal to the protection element 207. The controlling effect element 206 mixes the second part with the left channel signal 12 to form the second driving signal. In an embodiment, the controlling effect element 205 may adjust, before the first part is provided to the protection element 207, the sound volume or the phase of the first part under the control of the enhancing stereo module 203. The controlling element 206 may also adjust, before the second driving signal is provided to the protection element 208, the sound volume or the phase of the second driving signal under the control of the enhancing stereo module 203.

For example, when the enhancing stereo element 203 calculates the phase difference between the right channel signal 11 and the left channel signal 12, the enhancing stereo element 203 may instruct the controlling effect element 205 to adjust a phase of the first driving signal, and/or may instruct the controlling effect element 206 to adjust a phase of the second driving signal, so that a phase difference between the first driving signal and the second driving signal is set to a preset phase difference. The preset phase difference can make people feel the sound generated by the UE working in the tweeter mode/hands-free mode from a right/desired direction.

In another example, when the enhancing stereo element 204 calculates the volume difference between the right channel signal 11 and the left channel signal 12, the enhancing stereo element 203 may instruct the controlling effect element 205 to adjust a loudness of the first driving signal, and/or may instruct the controlling effect element 206 to adjust a loudness of the second driving signal, to balance the volume of sound generated by the first speaker 30 and the volume of sound generated by the second speaker 40.

By controlling the sound volume of the first driving signal and/or the second driving signal, the stereo effect of sound generated by the UE 10 in the tweeter mode/hands-free mode is enhanced or improved.

The protection element 207 receives the first driving signal from the controlling effect element 205, monitors a status of the first speaker 30 based on the first driving signal, and provides the first driving signal O1 to the first speaker 30. The status of the first speaker 30 may comprise: a lowest resonance frequency f0, and a Q parameter of the first speaker 30. The protection element 207 may feedback the status of the first speaker 30 to the filter 204. The filter 204 adjusts the threshold frequency to control which frequency components of the right channel signal 11 is provided to the first speaker 30 in the first driving signal. By controlling the amount of frequency components of the right channel signal 11 to be provided to the first speaker 30, it is ensured that the first speaker 30 doesn't get damaged, and the UE 10 will generate sound with a good quality and stereo effect.

The protection element 208 receives the second driving signal from the controlling effect element 206, monitors a status of the second speaker 40 based on the second driving signal, and provides the second driving signal O2 to the second speaker 40. The status of the second speaker 40 may comprise: a lowest resonance frequency f0, and a Q parameter of the second speaker 40.

In an embodiment, and the protection element 207 may further obtain the excursion and/or temperature of the first speaker 30, and control the first driving signal to avoid the first speaker 30 being damaged due to a too high temperature or a too high excursion based on the obtained excursion and/or temperature of the first speaker 30. Hence, the function of the protection element 208 is equal to the function of the protection element 207, wherein each protection element 207, 208 is adapted to its connected speaker 30, 40 to protect the speaker 30, 40 from damage.

The protection element 208 and the protection element 207 may communicate with each other, to balance volume of sound generated by the first speaker 30 and volume of sound generated by the second speaker 40. They may communicate with each other regarding information about gain, current, or voltage of driving signals to the first speaker 30 and the second speaker 40. For example, when the gain of the first driving signal is changed from a high value to a low value, the gain of the second driving signal is changed from a high value to a low value by the protection element 208, to keep volume of sound generated by the first speaker 30 and volume of sound generated by the second speaker 40 still balanced. This controlling may be dynamic, which means, once one parameter of one driving signal is changed, the corresponding parameter of the other driving signal will be changed instantly.

Though the audio signal is a stereo signal having the right channel signal 11 and the left channel signal 12 in this embodiment, the audio signal may be a mono signal in other embodiments. If the audio signal is a mono signal, it only needs to replace both input 11 and input 12 with the mono signal, and the other processing implemented by above mentioned elements is same as the embodiment with an audio signal being a stereo signal.

It should be known that the extracting attribute elements 201, 202, the enhancing stereo element 203, the controlling effect element 205, and protection elements 207, 208 are not necessary in some embodiments.

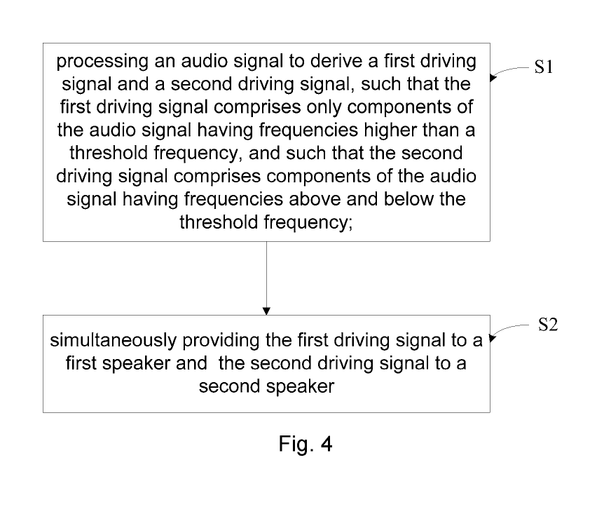

Corresponding to the processor 20 disclosed in above embodiments, FIG. 4 shows a method which would be implemented by the processor 20 to drive speakers comprised in the UE 10. The method comprises:

Step S1: processing the audio signal to derive a first driving signal and a second driving signal, such that the first driving signal comprises only components of the audio signal having frequencies higher than a threshold frequency, and such that the second driving signal comprises components of the audio signal having frequencies above and below the threshold frequency; and

Step S2: simultaneously providing the first driving signal to the first speaker 30 and the second driving signal to the second speaker 40

The first driving signal drives the first speaker 30 to generate sound, and the second driving signal drives the second speaker 40 to generate sound.

In this method, as both the first speaker 30 (e.g. a receiver or ear speaker) and the second speaker 40 (e.g. a tweeter or main speaker) are provided with driving signals simultaneously, the sound generated by an UE with the first speaker 30 and the second speaker 40 will have a very loudness. Further, the more high frequencies components sound contains, the better acoustic quality sound has. Accordingly, the acoustic quality of the sound generated by the UE 10 working in the tweeter mode/hands-free mode is better than that of sound generated by one speaker only. Moreover, the first driving signal provided by the processor to drive the first speaker 30 comprises only components of the audio signal having frequencies higher than the threshold frequency, no sound at low frequencies needs to be generated by the first speaker 30. Hence, noise like clipping produced by the first speaker 30 is avoided. Furthermore, the second driving signal still comprises the frequencies below the threshold frequency, so the second speaker 40 can generate sound at the low frequencies. Accordingly, the driving signals provided by this method can make the sound generated by the UE 10 have a large loudness and still comprise information related to the low frequencies, but without a noise like clipping.

The method disclosed here is utilized by the processor 20 to drive the first speaker 30 and the second speaker 40, so the method may further comprise more details discussed in any one of foregoing embodiments.

It should be noted that in the above the right channel can be replaced by left channel and accordingly left channel can be replaced by right channel.

Furthermore, any method according to the present invention may be implemented in a computer program, having code means, which when run by processing means causes the processing means to execute the steps of the method. The computer program is included in a computer readable medium of a computer program product. The computer readable medium may comprises of essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that the processor 20 of the present UE 10 may comprise, e.g., one or more instances of a Central Processing Unit (CPU), a Digital Signal Processing (DSP) device, a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the present invention is not limited to the embodiments described above, but also relates to and incorporates all embodiments within the scope of the appended independent claims.

1-15. (canceled)

16. A user device, comprising:
at least one processor;
a non-transitory computer-readable storage medium coupled to the at least one processor and storing programming instructions for execution by the at least one processor, the programming instructions instruct the at least one processor to:
derive a first driving signal and a second driving signal by processing an audio signal, wherein the first driving signal comprises only components of the audio signal having frequencies higher than a threshold frequency and the second driving signal comprises components of the audio signal having frequencies above and below the threshold frequency; and
simultaneously provide the first driving signal and the second driving signal;
a first speaker configured to generate sound based on the first driving signal; and
a second speaker configured to generate sound based on the second driving signal.

17. The user device according to claim 16, wherein the the programming instructions further instruct the at least one processor to adjust the threshold frequency.

18. The user device according to claim 17, wherein the threshold frequency is 1000 Hz or wherein a minimum of the adjustable threshold frequency is 1000 Hz.

19. The user device according claim 18, wherein the audio signal comprises a first channel signal and a second channel signal, and
wherein the programming instructions further instruct the at least one processor to filter the first channel signal to derive high frequency components of the first channel signal having frequencies higher than the threshold frequency and low frequency components of the first channel signal having frequencies not higher than the threshold frequency,
wherein the programming instructions further instruct the at least one processor to derive the first driving signal based on the high frequency components of the first channel signal;
wherein the programming instructions further instruct the at least one processor to derive the second driving signal based on the second channel signal and the low frequency components of the first channel signal.

20. The user device according to claim 19,
wherein the programming instructions further instruct the at least one processor to calculate a volume difference between the first channel signal and the second channel signal, and
wherein the programming instructions further instruct the at least one processor to adjust the first driving signal or the second driving signal based on the calculated volume difference to reduce the volume difference between the first driving signal and the second driving signal when compared to the calculated volume difference.

21. The user device according to claim 20,
wherein the programming instructions further instruct the at least one processor to calculate the phase difference between the first channel signal and the second channel signal, and
wherein the programming instructions further instruct the at least one processor to adjust the phase of the first driving signal or the phase of the second driving signal based on the calculated phase difference to set the phase difference between the first driving signal and the second driving signal to a preset phase difference.

22. The user device according to claim 21,
wherein the programming instructions further instruct the at least one processor to simultaneously provide the first driving signal and the second driving signal when the user device is in hands-free or tweeter mode,
wherein the programming instructions further instruct the at least one processor to stop providing the second driving signal and continue providing the first driving signal when the user device is switched to a receiver or handheld mode.

23. The user device according to claim 22,
wherein the programming instructions further instruct the at least one processor to obtain status information of the first speaker, and
wherein the programming instructions further instruct the at least one processor to adjust the threshold frequency based on the obtained status information of the first speaker.

24. The user device according to claim 23,
wherein the status information of the first speaker comprises at least one of the following: a current lowest resonance frequency f0, or a current Q parameter of the first speaker.

25. The user device according to claim 24,
wherein the programming instructions further instruct the at least one processor to obtain a temperature or excursion of the first speaker, and to control the first driving signal to ensure that the first speaker operates within a predefined maximum temperature or a predefined maximum excursion, respectively.

26. The user device according to claim 25, wherein the programming instructions further instruct the at least one processor to adjust the first driving signal and the second driving signal to balance the volume of the sound generated by the first speaker and the volume of the sound generated by the second speaker.

27. The user device according to claim 26, wherein a size of the first speaker is smaller than a size of the second speaker.

28. The user device according to claim 27, wherein the first speaker is an ear speaker and the second speaker is a main speaker.

29. A method for driving speakers comprised in a user device, wherein the method comprises:
processing an audio signal to derive a first driving signal and a second driving signal, wherein the first driving signal comprises only components of the audio signal having frequencies higher than a threshold frequency, and the second driving signal comprises components of the audio signal having frequencies above and below the threshold frequency; and
simultaneously providing the first driving signal to a first speaker and the second driving signal to a second speaker, wherein the first speaker and the second speaker are comprised in the user device;
wherein the first driving signal is adapted to drive the first speaker to generate sound, and the second driving signal is adapted to drive the second speaker to generate sound.

30. A non-transitory computer program, when executed by a computer, instructing the computer to perform operations comprising:
processing an audio signal to derive a first driving signal and a second driving signal, wherein the first driving signal comprises only components of the audio signal having frequencies higher than a threshold frequency, and such that the second driving signal comprises components of the audio signal having frequencies above and below the threshold frequency; and
simultaneously providing the first driving signal to a first speaker and the second driving signal to a second speaker, wherein the first speaker and the second speaker are comprised in the computer;
wherein the first driving signal is adapted to drive the first speaker to generate sound, and the second driving signal is adapted to drive the second speaker to generate sound.
